(19) United States
(12) Patent Application Publication
(10) Pub. No.: US 2009/0249246 A1
(43) Pub. Date: Oct. 1, 2009

(54) METHOD FOR TRANSMITTING INSTANT MESSAGE WHILE COMPUTER WORKING IN A FULL-SCREEN MODE

(75) Inventors: Chun-Kai Chan, Taipei (TW); Li-Hsiang Liao, Taipei (TW); Ching-Jan Lu, Taipei (TW); Kao-Yi Chiu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/406,930

(22) Filed: Mar. 18, 2009

(30) Foreign Application Priority Data
Mar. 27, 2008 (TW) 97111017

(51) Int. Cl. G06F 3/048; G06F 15/16

(52) U.S. Cl. 715/802; 709/206

(57) ABSTRACT

Methods for transmitting an instant message while a computer working in a full-screen mode. The method includes a computer executing the full-screen mode and a display control program first, and then fetching a message from an instant messenger module, and transmitting the message to the display control program, which embeds the message into a frame to be displayed next by the full-screen mode, and displaying the frame with the message. In such a way, a user is allowed to transmit and receive the message via the instant messenger module while a computer working in a full-screen mode, thus improving the convenience of using the full-screen mode.

### CROSS-REFERENCE TO RELATED APPLICATION

This application claims the priority benefit of Taiwan application serial no. 97111017, filed on Mar. 27, 2008. The entirety of the above-mentioned patent application is hereby incorporated by reference herein and made a part of specification.

### BACKGROUND OF THE INVENTION

1. Field of the Invention

The present invention generally relates to a method for transmitting an instant message, and more particularly, to a method for transmitting an instant message while computer working in a full-screen mode.

2. Description of Related Art

Nowadays, people are living with a fast pace, and most of them love to enjoy personal favourite activities in leisure. However, in such a busy and stressful environment, times and spaces suitable for leisure activities are highly restricted. Therefore, recreational PC games such as puzzle games within sounds and lights that are easily fetched have become more and more popular.

When a PC game is played, frames of the game are often displayed in a full-screen mode. However, in the full-screen mode, the user views only the window of the frames of the PC game, and is the windows of other application programs can not be viewed. For example, if the user has been using an instant messenger application before starting the PC game, then the full-screen mode displayed frames of the PC game will cover the frame of the instant messenger application after the PC game is started. In such a way, the user will not be alerted by a message newly received by the instant messenger application. Therefore, the user cannot play the game while keeping talk with others via the instant messenger application.

Most PC game includes message transmission functions, allowing players to exchange information and communicate online when playing the game. Unfortunately, such a function only allows the user to communicate with other online-players of the game. In other words, should the user desire to send a message to a party not playing the game, he has to quit the game first, and then send a message to the party by a selected instant messenger application, which is believed to be very inconvenient.

### SUMMARY OF THE INVENTION

Accordingly, the present invention is directed to provide a method for transmitting an instant message while a computer working in a full-screen mode. The method allows a user to instantly receive and transmit a message via an instant messenger module.

The present invention provides a method for transmitting an instant message while a computer working in a full-screen mode. In the method, the full-screen mode and a display control program are executed first, and then a message is fetched from an instant messenger module. The message is transmitted to the display control program, and the display control program embeds the message into a frame to be displayed next by the full-screen mode. Finally, the frame with the message is displayed in the screen.

According to an embodiment of the present invention, the method further includes executing the instant messenger module and logging in a user account by the instant messenger module before executing the full-screen mode.

According to an embodiment of the present invention, the method further includes periodically calling an message receiving function of the instant messenger module, for determining whether the instant messenger module receives the message or not. When it is determined that the instant messenger module receives the message, a contact account determining function is called to obtain a corresponding contact account, and a message fetching function is called to obtain content of the message. Further, the step of displaying the frame with the message includes embedding the message together with the corresponding contact account into the frame.

Viewing from another aspect, the present invention further provides a method for transmitting an instant message while a computer working in a full-screen mode. In the method, the full-screen mode and a display control program are executed, an instant message interface is embedded into a frame to be displayed next by the full-screen mode, and the frame with the instant message interface is displayed. Then, a message inputted by a user is received by a message input interface and transmitted to an instant messenger module. Finally, the instant messenger module sends out the message.

According to an embodiment of the present invention, in the step of displaying the frame with the instant message interface, a contact list fetching function of the instant messenger module is called to display a contact list including at least one contact, a contact selecting instruction is received to select one contact from the contact list, and an instant messenger interface corresponding to the selected contact is displayed.

According to an embodiment of the present invention, the method further includes receiving an input message transmitted from the contact. The step of displaying the frame with the instant messenger interface includes displaying an instant messenger interface corresponding to the contact.

According to an embodiment of the present invention, the step of transmitting the message to the instant messenger module includes calling a message transmitting function of the instant messenger module for transmitting content of the message to the instant messenger module.

According to an embodiment of the present invention, the full-screen mode includes a game program, and the display control program is installed in a graphic card for adjusting a display setting of the graphic card. Further, the instant messenger module includes MSN messenger®, Yahoo messenger®, or SKYPE®, and the message includes text information or file transmission information.

The present invention fetches or transmits a message by calling functions of the instant messenger module, and thus is adapted for receiving and transmitting a message while a computer working in a full-screen mode. When the message is received, the present invention combines the message to a frame via the display control program, and then displays the frame. When transmitting the message, the present invention receives the message inputted by the user via the display control program, and then sends out the message via the instant messenger module.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a method for transmitting an instant message while a computer working in a full-screen mode according to an embodiment of the present invention.

FIG. 2 is a flow chart illustrating a method for transmitting an instant message while computer working in a full-screen mode according to another embodiment of the present invention.

FIG. 3 is a flow chart illustrating a method for displaying a specific instant message interface according to an embodiment of the present invention.

FIG. 4 is a flow chart illustrating a method for displaying a specific instant message interface according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The instant messenger application drastically improves the convenience for modern people to communicate with others. If a user is allowed to receive/transmit a message via an instant messenger application while computer working in a full-screen mode, the user can keep communicating with others instantly. Accordingly, the present invention provides a method for transmitting an instant message while executing a full-screen mode in view of the foregoing objects.

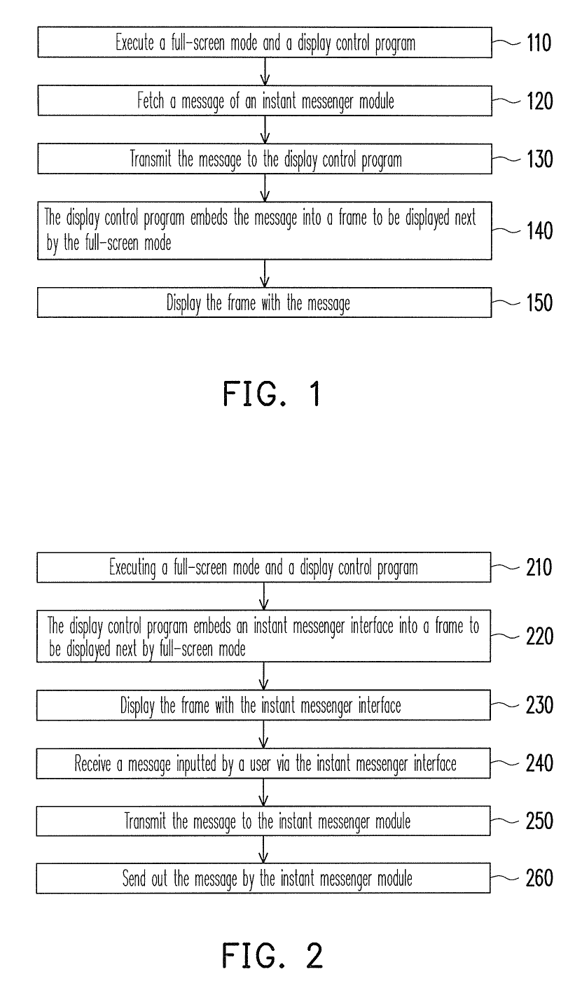

FIG. 1 is a flow chart illustrating a method for transmitting an instant message while computer working in a full-screen mode according to an embodiment of the present invention. An object of the current embodiment is to transmit an instant message by an instant messenger module. In accordance with the object of the current embodiment, it is assumed that the user of the current embodiment has previously executed the instant messenger module on the computer system, and has previously logged in a user account with the instant messenger module. The instant messenger module can be, but is not restricted to be, instant communicating application such as MSN messenger®, Yahoo messenger®, or SKYPE®.

Referring to FIG. 1, first, at step 1 10, a full-screen mode and a display control program are executed by the computer system. In the current embodiment, the full-screen mode can be, but is not restricted to be, an online game application or a console game application. When the computer game is being played, an execution frame is compulsorily displayed on the computer monitor in full-screen.

Then, at step 120, a message received by the instant messenger module is fetched at a specific time point. The instant messenger module provides a plurality of different application programming interfaces (API). In the current embodiment, functions provided by the APIs can be used to communicate with the instant messenger module. For example, after every certain time, the current embodiment actively calls a message receiving function of the instant messenger module to determine whether the instant messenger module receives any message transmitted from a network or not. If it is determined that the instant messenger module receives a message, the current embodiment fetches content of the received message by calling a message fetching function of the instant messenger module, and obtains an account of a contact that transmits the message by calling a contact account determining function. The message received by the instant messenger module can be, but is not restricted to, text information or file transmission information.

Then, at step 130, the fetched content of the message and the contact account are transmitted to the display control program. The display control program is installed in the graphic card for adjusting a display setting of the graphic card.

Finally, at step 140, the display control program embeds the message into a frame to be displayed next by the full-screen mode. Further, the display control program may also embed the content of the message and the account of the contact that transmits the message into the frame to be displayed next. At step 150, the frame with the message is displayed. Specifically, the display control program embeds or attaches the message to the frame to be displayed next in a frame buffer. As such, when a previous frame has been displayed and the next frame is being displayed, the user can view the frame with the message.

By executing the foregoing steps, the user is capable of viewing the content of the message sent from his family, or friends, via the instant messenger module, while computer working in a full-screen mode. Further, in addition to instantly receiving the instant message, the present invention is also adapted for instantly transmitting an instant message as desired while computer working in a full-screen mode. Details of doing so are to be illustrated in the embodiment as discussed below.

FIG. 2 is a flow chart illustrating a method for transmitting an instant message while computer working in a full-screen mode according to another embodiment of the present invention. Referring to FIG. 2, at step 210, a full-screen mode (e.g., a game program) is executed and a display control program is started. Then, at step 220, the display control program embeds an instant messenger interface into a frame to be displayed next by the full-screen mode. At step 230, the frame with the instant messenger interface is displayed. It should be noted herein that the user is allowed to either actively send a message, or reply a feedback message when receiving an inward message, such that the details for displaying the instant messenger interface may vary with respect to the previously mentioned two situations.

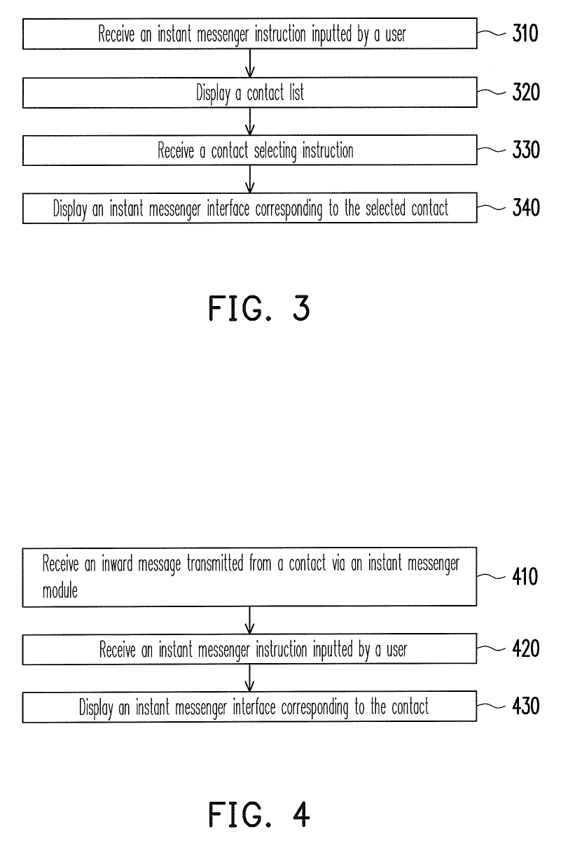

According to an embodiment of the present invention, when the user desires to actively send a message to a contact listed in the contact list, he may initiate an instant messenger instruction by operating a keyboard (e.g., pressing a predetermined key). FIG. 3 is a flow chart illustrating a method for displaying a specific instant message interface according to an embodiment of the present invention. Referring to FIG. 3, at step 310, an instant messenger instruction initiated by the user is received. Then, at step 320, a contact list fetching fanction of the instant messenger module is called, to display a contact list including a plurality of contacts of the user in a frame. Then, the user may select one of the contacts from the contact list, and initiates a corresponding contact selecting instruction at step 330. Therefore, at step 340, based on the received contact selecting instruction, an instant messenger interface corresponding to the selected contact is displayed in the frame.

FIG. 4 is a flow chart illustrating a method for displaying a specific instant message interface according to an embodiment of the present invention. Referring to FIG. 4, at step 410, it is pre-assumed that the instant messenger module has received an inward message sent from one of the contacts, and the content of the inward message is displayed in the frame by executing the steps as shown in FIG. 1. When the user reads the content of the inward message, and desires to reply, he may initiate an instant messenger instruction by operating the keyboard (e.g., press an “enter” key). At step 420, the instant messenger instruction initiated by the user is received. Then, at step 430, an instant messenger interface corresponding to the contact that sent the inward message is displayed.

Consequently, as shown in FIG. 2, at step 240, the instant messenger interface displayed by the display control program is used for receiving a message inputted by the user. The message inputted by the user can be, but is not restricted to, text information or file transmission information. Then, at step 250, a message transmission function of the instant messenger module is called to transmit the message inputted by the user to the instant messenger module. Finally, at step 260, the instant messenger module sends out the message inputted by the user, in which the instant messenger module may transmit the message inputted by the user to an external device. The external device can be, but is not restricted to, a computer, a mobile phone, or a personal digital assistant used by another user.

In accordance with the steps as discussed above, the user is allowed to actively send an instant message via an instant messenger module (e.g., MSN messenger®, Yahoo messenger®, or SKYPE®) while playing a computer game, and is also allowed to instantly reply a message received from others via the instant messenger module, which brings convenience in operating the computer.

Although the present invention is illustrated by embodiments of receiving and transmitting a message, it should be noted that all functions of the instant messenger module should have been taught as applicable by calling the functions (e.g., fetching the contact list) provided by the instant messenger module.

In summary, according to the present invention, the user is allowed to receive the message transmitted from other contacts via the instant messenger module while computer working in a full-screen mode, and is further allowed to instantly send out a message via the instant messenger module. In such a way, the instant message communication between different users is not restricted by the executed full-screen mode any more, and the full-screen mode can be more conveniently and flexibly for use.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for transmitting an instant message while computer working in a full-screen mode, comprising:
executing the full-screen mode and a display control program;
fetching a message from an instant messenger module;
transmitting the message to the display control program;
embedding the message by the display control program into a frame to be displayed next by the full-screen mode; and
displaying the frame with the message embedded therein.

2. The method according to claim 1 further comprising:
executing the instant messenger module; and
logging in a user account by the instant messenger module.

3. The method according to claim 1, wherein, after the step of executing the full-screen mode, the method further comprises:
periodically calling an message receiving function of the instant messenger module, for determining whether the instant messenger module receives the message or not; and
calling a contact account determining function to obtain a contact account corresponding to the message when it is determined that the instant messenger module receives the message.

4. The method according to claim 3, wherein the step of displaying the frame with the message embedded therein comprises:
displaying the frame including the contact account corresponding to the message.

5. The method according to claim 1, wherein the step of fetching the message from the instant messenger module comprises:
calling a message fetching function to obtain content of the message.

6. The method according to claim 1, wherein the full-screen mode comprises a game program.

7. The method according to claim 1, wherein the display control program is installed in a graphic card for adjusting a display setting of the graphic card.

8. The method according to claim 1, wherein the instant messenger module comprises MSN messenger®, Yahoo messenger®, or SKYPE®.

9. The method according to claim 1, wherein the message comprises text information or file transmission information.

10. A method for transmitting an instant message while computer working in a full-screen mode, comprising:
executing the full-screen mode and a display control program;
embedding an instant message interface by the display control program into a frame to be displayed next by the full-screen mode;
displaying the frame with the instant message interface embedded therein;
receiving a message inputted by a user via a message input interface;
transmitting the message to an instant messenger module; and
sending out the message by the instant messenger module.

11. The method according to claim 10, wherein before the step of embedding an instant message interface by the display control program into a frame to be displayed next by the full-screen mode, the method further comprises:
receiving an instant messenger instruction inputted by the user.

12. The method according to claim 10, wherein the step of displaying the frame with the instant message interface embedded therein comprises:
calling a contact list fetching function of the instant messenger module, for displaying a contact list comprising at least one contact;
receiving a contact selecting instruction for selecting one contact from the contact list; and
displaying the instant messenger interface corresponding to the selected contact.

13. The method according to claim 10, further comprising:
receiving an input message transmitted from the contact via the instant messenger module.

14. The method according to claim 13, wherein the step of displaying the frame with the instant messenger interface comprises:
displaying the instant messenger interface corresponding to the contact.

15. The method according to claim 10, wherein the step of transmitting the message to the instant messenger module comprises:
calling a message transmitting function of the instant messenger module, for transmitting content of the message to the instant messenger module.

16. The method according to claim 10, wherein the step of sending out the message by the instant messenger module comprises sending the message to an external device by the instant messenger module.

17. The method according to claim 1, wherein the display control program is installed in a graphic card for adjusting a display setting of the graphic card.

18. The method according to claim 10, wherein the display control program is installed in a graphic card for adjusting a display setting of the graphic card.

19. The method according to claim 10, wherein the instant messenger module comprises MSN messenger®, Yahoo messenger®, or SKYPE®.

20. The method according to claim 10, wherein the message comprises text information or file transmission information.
